(19) United States
(12) Patent Application Publication
(10) Pub. No.: US 2011/0132083 A1
(43) Pub. Date: Jun. 9, 2011

(54) Low Temperature Gas Flow Sensor

(75) Inventor: Michael D. Newman, Hillsborough, NJ (US)

(73) Assignee: Linde Aktiengesellschaft, Munich (DE)

(21) Appl. No.: 12/631,246

(22) Filed: Dec. 4, 2009

(51) Int. Cl. G01F 1/688

(52) U.S. Cl. 73/204.23

(57) ABSTRACT

A method, and apparatus therefor, for detecting the presence of a target amount of gas flowing within a conduit, including: providing a heating element in operational contact with the conduit; heating at least one of the conduit or the gas; measuring the temperature of at least one of the heating element, the conduit or the gas; comparing the measured temperature of at least one of the heating element, the conduit or the gas to data relating to a target temperature; controlling and measuring the amount of energy consumed by the heating element in order to maintain the target temperature; correlating the amount of energy consumed by the heating element in order to maintain the target temperature with an amount of gas flowing within the conduit; and determining whether the amount of gas flowing within the conduit is at least the target amount of gas flowing within the conduit.

The present apparatus and methods are related to detecting the presence of, and/or measuring the velocity of, gas flow in systems which utilize low temperature gases, such as refrigeration systems or cryogenic food freezing systems.

Measuring the exhaust gas flow in refrigeration systems may be difficult and unreliable. Food refrigeration systems may utilize either nitrogen or carbon dioxide as a refrigerant fluid. Both gases can displace breathable air, which may be hazardous to unsuspecting workers. Therefore, safely exhausting these gases from food refrigeration systems is desirable for the safety of the production facility.

Nitrogen and carbon dioxide may be extremely cold when utilized in refrigeration systems. Due to the low exhaust gas temperature, ice crystals form and mix with contaminant food particles in the gas, making accurate flow measurement difficult. Without accurate flow measurement, ensuring that proper exhaust ventilation occurs may be difficult.

Common devices utilized in nitrogen and carbon dioxide exhaust flow measurement are differential pressure switches. These differential pressure switches may be inserted directly into the exhaust gas conduit or across the outlet of the exhaust gas blower. These switches rely on the measurement of pressure differential and are susceptible to the accumulation of snow and ice around and inside the measurement tubes. Exhaust gases flow into a measurement tube within the differential pressure switch, where the gas pressure in the switch may be converted into an electrical signal which indicates flow. The presence of snow and/or ice crystals and food particles reduces the cross sectional area in the measurement tube, thus reducing flow through the differential pressure switch. If the flow through the differential pressure switch has been reduced even by only a partial blockage within the measurement tube, the switch will provide inaccurate flow information to system monitors. For these reasons, differential pressure switches are unreliable when used in food refrigeration and freezing applications.

What is needed is an apparatus which can accurately detect and/or measure low temperature gas flow which is not readily affected by the deposition of solid material on or near the apparatus.

For a more complete understanding of the present low temperature gas flow sensor. reference may be made to the following description of the low temperature gas flow sensor embodiments, in conjunction with the following drawings, of which:

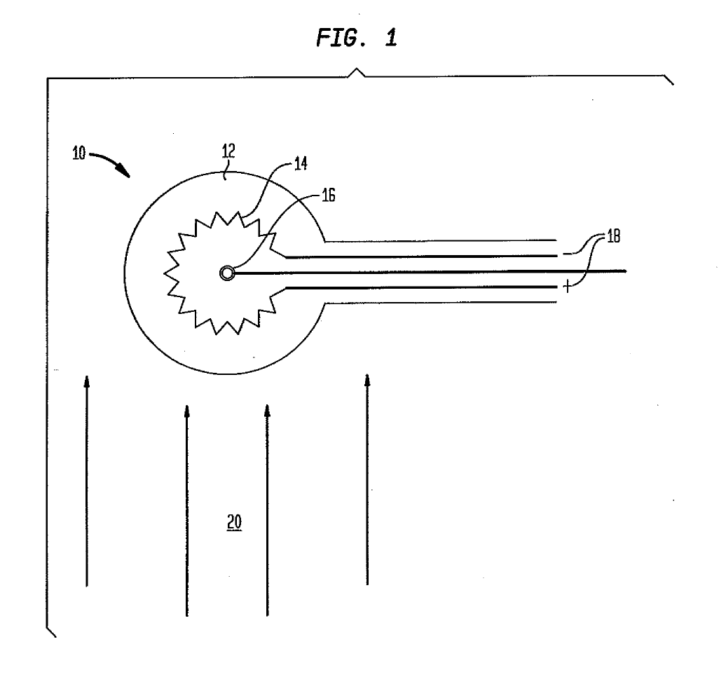

FIG. 1 is a side view, in cross-section, of an embodiment of the heating element of the present low temperature gas flow sensor.

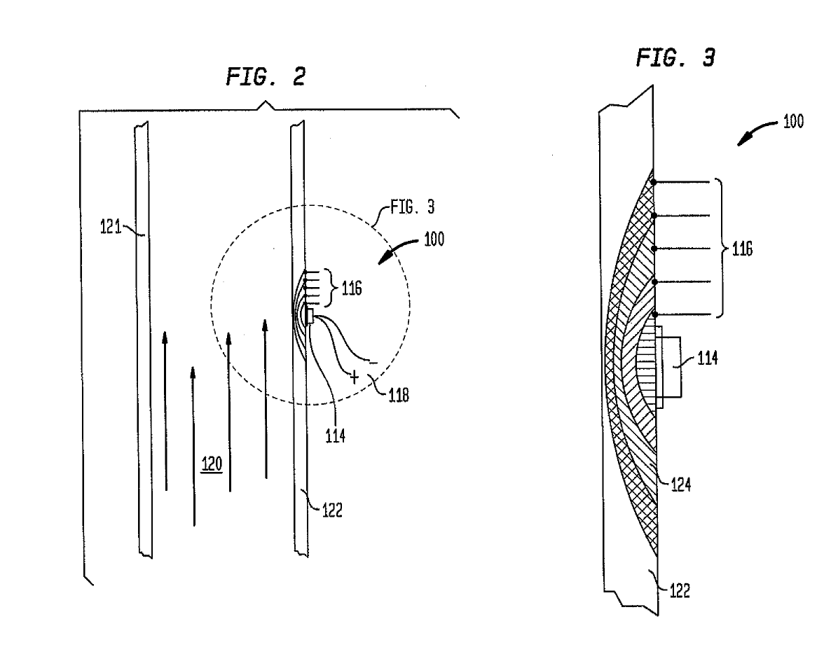

FIG. 2 is a schematic side plan view in cross-section of an embodiment of the present low temperature gas flow sensor.

FIG. 3 is a schematic side plan view in cross-section of a portion of the embodiment shown in FIG. 2.

An apparatus is provided for detecting a presence of a target amount of gas flow of a gas flowing within a conduit, comprising: at least one heating element engaged with the conduit capable of heating at least one of the gas or the conduit, the at least one heating element being in electrical communication with at least one source of electrical energy; at least one thermocouple engaged with the conduit capable of measuring a temperature of at least one of the heating element, the gas or the conduit; a temperature controller for substantially controlling the temperature of at least one of the heating element, the gas or the conduit to a selected temperature, the temperature controller being in electronic communication with the at least one source of electrical energy and the at least one thermocouple; and a device capable of determining the presence of the target amount of gas flow by receiving data relating to an amount of electrical energy consumed by the at least one heating element in order to maintain the selected temperature, and determining whether the amount of electrical energy is indicative of the presence of the target amount of gas flow, the device being in electronic communication with the at least one source of electrical energy; and optionally wherein the temperature controller comprises the device capable of determining the presence of the target amount of gas flow.

Also provided is an apparatus for determining a velocity of a gas flowing within a conduit, comprising: at least one heating element engaged with the conduit capable of heating at least one of the gas or the conduit, the at least one heating element being in electrical communication with at least one source of electrical energy; at least one thermocouple engaged with the conduit capable of measuring a temperature of at least one of the heating element, the gas or the conduit; a temperature controller for substantially controlling the temperature of at least one of the heating element, the gas or the conduit to a selected temperature, the temperature controller being in electronic communication with the at least one source of electrical energy and the at least one thermocouple; and a device capable of measuring an amount of electrical energy consumed by the at least one heating element in order to maintain the selected temperature of the gas, the device being in electronic communication with the at least one source of electrical energy; optionally wherein the temperature controller comprises the device capable of measuring the amount of electrical energy consumed by the at least one heating element.

The apparatus may further comprise means for determining the velocity of the gas flowing within the conduit by analyzing the amount of electrical energy consumed by the at least one heating element. In one embodiment, the temperature controller may comprise the means for determining the velocity of the gas flowing within the conduit. In a further embodiment, the means for determining the velocity of the gas flowing within the conduit may comprise the device capable of measuring an amount of electrical energy consumed by the at least one heating element in order to maintain the selected temperature of the gas, the device being in electronic communication with the at least one source of electrical energy.

The temperature controller may analyze data relating to the temperature measured by the at least one thermocouple, and may be capable of controlling the amount of electrical energy supplied to the heating element. In certain embodiments, the at least one heating element and the at least one thermocouple may be engaged with the exterior surface of the conduit.

The heating element(s) may be any device which converts electrical energy into heat, such as a heating coil. The thermocouple(s) may be any device which is capable of directly or indirectly measuring the temperature of a surface and/or a fluid.

The temperature controller may be any device which is capable of monitoring the temperature measured by the thermocouple(s) and controlling the amount of electrical energy supplied to the heating element(s), such as a thermostat. The temperature controller may also comprise an electronic processor (such as a microprocessor or a computer) which is additionally capable of measuring the amount of electrical energy consumed by the heating element(s), determining the presence of a target amount of gas, and/or measuring the velocity of the gas.

Without limitation, the source of electrical energy may be from a local electrical energy grid, or from alternative sources, such as a dedicated wind turbine or solar panel, a battery or batteries, or devices associated with other processes within the facility that generate electricity.

In certain embodiments, the apparatus may further comprise a metallic mass comprising at least one heating element and at least one thermocouple. and wherein the metallic mass penetrates the conduit such that the metallic mass is in direct contact with or exposed to the gas flowing within the conduit. The metallic mass may be any suitably sized and shaped metallic mass, such as but not limited to a copper sphere.

Referring to FIG. 1, an embodiment of the present apparatus 10 comprises a copper sphere 12, a heating element 14 and a thermocouple 16. The heating element 14 is connected to a source of electrical energy 18. In this embodiment, the apparatus 10 penetrates an exhaust conduit (not shown) of a cryogenic freezer, and is directly in contact with the exhaust cryogen 20 flowing within the conduit. The heating element 14 and thermocouple 16 are in electronic communication with a device (not shown) capable of maintaining the temperature of the copper sphere 12, as measured by the thermocouple 16 at a selected temperature, by varying the output of the source of electrical energy 18 to the heating element 14.

Should the velocity of the exhaust cryogen 20 flowing within the conduit fluctuate, the amount of electrical energy required to maintain the selected temperature of the copper sphere 12 will fluctuate directly proportional to the fluctuations in the velocity of the exhaust cryogen 20. This occurs because the exhaust cryogen 20 flowing around and past the copper sphere 12 will cool the copper sphere 12 in proportion to the amount of exhaust cryogen 20 contacting the copper sphere 12. As the velocity of the exhaust cryogen 20 increases, a greater amount of electrical energy will be utilized by the heating element 14 in order to maintain the temperature of the copper sphere 12. Conversely, if the exhaust cryogen 20 velocity decreases, less electrical energy will be consumed by the heating element 14. Thus, it may be determined whether the amount of exhaust cryogen 20 flowing within the conduit is sufficient to effectively ventilate the cryogenic freezer and ensure that the cryogen fluid does not contaminate the environment around the cryogenic freezer. The velocity of the exhaust cryogen 20 may also be determined.

Referring to FIGS. 2 and 3, an embodiment of the present apparatus 100 comprises a heating element 114 and thermocouple(s) 116 engaged with the exterior surface of a conduit wall 122 of a conduit 121 for exhaust cryogen 120 flowing out of a cryogenic freezer (not shown). The heating element 114 is connected to a source of electrical energy 118. The heating element 114 and thermocouple(s) 116 are in electronic communication with a device (not shown) capable of receiving data related to the local temperatures measured by the individual thermocouple(s) 116 engaged with the conduit wall 122 near the heating element 114.

The heating element 114 creates a temperature gradient 124 within the conduit wall 122. The temperature gradient 124 is measured by the thermocouple(s) 116, the thermocouples being engaged or in contact with the conduit wall 122 at varying distances from the heating element 114. As the velocity of the exhaust cryogen 120 fluctuates, the temperature gradient 124 will fluctuate. In other words, with the heating element 114 operating at constant temperature, as the velocity of the exhaust cryogen 120 increases, the temperature indicated by the thermocouple(s) 116 furthest from the heating element 114 will decrease, because the higher velocity of the exhaust cryogen 120 will more quickly cool the conduit wall 122. In this manner, whether the exhaust cryogen 120 flowing within the conduit 121 is sufficient to ventilate the cryogenic freezer may be determined by the characteristics of the temperature gradient 124. Further, the velocity of the exhaust cryogen 120 may be determined by the characteristics of the temperature gradient 124.

Also provided is a method of detecting the presence of a target amount of gas flowing within a conduit, comprising: providing a heating element in operational contact with the conduit; heating at least one of the conduit or the gas flowing within the conduit; measuring the temperature of at least one of the heating element, the conduit or the gas flowing within the conduit; comparing the measured temperature of at least one of the heating element, the conduit or the gas flowing within the conduit to data relating to a target temperature; controlling and measuring the amount of energy consumed by the heating element in order to maintain the target temperature; correlating the amount of energy consumed by the heating element in order to maintain the target temperature with an amount of gas flowing within the conduit; and determining whether the amount of gas flowing within the conduit is at least the target amount of gas flowing within the conduit.

The method may also be used to determine a volumetric flow of a gas flowing within a conduit by further comprising determining the volumetric flow of the gas flowing within the conduit by analyzing the amount of gas flowing within the conduit in conjunction with a cross-sectional flow area of the conduit.

### EXAMPLE

Referring again to FIG. 1, a 10 inch (25.4 cm) diameter cylindrical conduit (not shown) is exhausting an exhaust cryogen 20 (for purposes of illustration, nitrogen gas) at a temperature of −100° F. (−73.3° C.) from a food freezing system (not shown). A copper sphere 12 is mounted within the conduit so that it is completely exposed to the exhaust cryogen 20, the exhaust cryogen 20 having a velocity of 100 ft/min. (30.5 m/min.). The copper sphere 12 is 0.5 inches (1.3 cm) in diameter and weighs 0.021 pounds (9.53 g). An embedded heating element 14 and thermocouple 16 work in conjunction to maintain the copper sphere 12 at a temperature of 40° F. (4.4° C.).

The heat transfer coefficient (H) of a sphere residing in an airflow stream is represented with the following equation:

$$H = \frac{( k \times 0.37 ( {Re}^{0.6} ) )}{D}$$

wherein:

H=heat transfer coefficient in Btu/(hr×ft²×° F.);

k=thermal conductivity of the sphere in Btu/(hr×ft×° F.);

Re=the Reynolds number, wherein 17≦Re≦70,000; and

D=diameter of sphere in feet.

It is known that the thermal conductivity of copper is 231 Btu/(hr×ft×° F.) (400 W/(m×° C.). The diameter of the copper sphere 12 is 0.0416 feet (0.0127 m) and the Re is 17. The Reynolds number (Re) is a variable which is dependent on the velocity of the exhaust cryogen 20. Higher velocities will yield higher Re numbers. The resulting heat transfer coefficient of the copper sphere 12 will be 11,245 Btu/(hr×ft²×° F.) (63,852 W/(m²×° C.)).

According to Newton's law of cooling:

Q=HA(Tₛₚₕₑᵣₑ−Tₑₙᵥᵢᵣₒₙₘₑₙₜ)

wherein:

Q=heat transfer in Btu/hr;

H=heat transfer coefficient in Btu/(hr×ft²×° F.);

A=surface area of sphere in ft²;

Tₛₚₕₑᵣₑ=temperature of the sphere in ° F.; and

Tₑₙᵥᵢᵣₒₙₘₑₙₜ=temperature of the exhaust gas in ° F.

For this example, the heat transfer will be 8,582 Btu/hr (2,515 W). This is the energy input required to maintain the copper sphere 12 at a constant temperature of 40° F. (4.4° C.) in a temperature environment of −100° F. (−73.3° C.) with a Re of 17 and gas flow velocity of 100 ft/min. (30.5 m/min.). As the velocity of the exhaust cryogen 20 increases, so does the Re number and the energy required to maintain the copper sphere 12 at a constant temperature. A gas velocity can then be derived based on the energy required to maintain the temperature of the copper sphere 12.

Once the gas velocity is known, the total volumetric flow of the process can be determined by the following equation:

F=VA

wherein:

F=volumetric flow rate in ft³/min.;

V=velocity of gas in ft/min.; and

A=cross-sectional area of the duct in ft².

In this instance, the velocity is 100 ft/min. (30.5 m/min.) and the cross-sectional area of the duct is 0.546 ft² (0.0507 m²). Therefore, the volumetric flow rate is 54.6 ft³/min. (1.55 m³/min.).

It will be understood that the embodiments described herein are merely exemplary and that a person skilled in the art may make many variations and modifications without departing from the spirit and scope of the invention. All such variations and modifications are intended to be included within the present embodiments as described and claimed herein. It should be understood that the embodiments described above are not only in the alternative, but may be combined.

What is claimed is:

1. An apparatus for detecting a presence of a target amount of gas flow of a gas flowing within a conduit, comprising:
at least one heating element engaged with the conduit capable of heating at least one of the gas or the conduit, the at least one heating element being in electrical communication with at least one source of electrical energy;
at least one thermocouple engaged with the conduit capable of measuring a temperature of at least one of the heating element, the gas or the conduit;
a temperature controller for substantially controlling the temperature of at least one of the heating element, the gas or the conduit to a selected temperature, the temperature controller being in electronic communication with the at least one source of electrical energy and the at least one thermocouple; and
a device capable of determining the presence of the target amount of gas flow of the gas flowing within the conduit by receiving data relating to an amount of electrical energy consumed by the at least one heating element in order to maintain the selected temperature, and determining whether the amount of electrical energy is indicative of the presence of the target amount of gas flow, the device being in electronic communication with the at least one source of electrical energy; and
optionally wherein the temperature controller comprises the device capable of determining the presence of the target amount of gas flow.

2. The apparatus of claim 1, wherein the temperature controller analyzes data relating to the temperature measured by the at least one thermocouple.

3. The apparatus of claim 1, wherein the temperature controller is capable of controlling the amount of electrical energy supplied to the heating element.

4. The apparatus of claim 1, wherein the apparatus further comprises a metallic mass comprising at least one heating element and at least one thermocouple, and wherein the metallic mass penetrates the conduit such that the metallic mass is in direct contact with the gas flowing within the conduit.

5. The apparatus of claim 4, wherein the metallic mass comprises a copper sphere.

6. The apparatus of claim 1, wherein the at least one heating element and the at least one thermocouple are engaged with the exterior surface of the conduit.

7. An apparatus for determining a velocity of a gas flowing within a conduit, comprising:
at least one heating element engaged with the conduit capable of heating at least one of the gas or the conduit, the at least one heating element being in electrical communication with at least one source of electrical energy;
at least one thermocouple engaged with the conduit capable of measuring a temperature of at least one of the heating element. the gas or the conduit;
a temperature controller for substantially controlling the temperature of at least one of the heating element, the gas or the conduit to a selected temperature, the temperature controller being in electronic communication with the at least one source of electrical energy and the at least one thermocouple; and
a device capable of measuring an amount of electrical energy consumed by the at least one heating element in order to maintain the selected temperature of the gas, the device being in electronic communication with the at least one source of electrical energy; and
optionally wherein the temperature controller comprises the device capable of measuring the amount of electrical energy consumed by the at least one heating element.

8. The apparatus of claim 7, further comprising means for determining the velocity of the gas flowing within the conduit by analyzing the amount of electrical energy consumed by the at least one heating element.

9. The apparatus of claim 8, wherein the temperature controller comprises the means for determining the velocity of the gas flowing within the conduit.

10. The apparatus of claim 8, wherein the means for determining the velocity of the gas flowing within the conduit comprises the device capable of measuring an amount of electrical energy consumed by the at least one heating element in order to maintain the selected temperature of the gas, the device being in electronic communication with the at least one source of electrical energy.

11. The apparatus of claim 7, wherein the temperature controller analyzes data relating to the temperature measured by the at least one thermocouple.

12. The apparatus of claim 7, wherein the temperature controller is capable of controlling the amount of electrical energy supplied to the heating element.

13. The apparatus of claim 7, wherein the apparatus further comprises a metallic mass comprising at least one heating element and at least one thermocouple, and wherein the metallic mass penetrates the conduit such that the metallic mass is in direct contact with the gas flowing within the conduit.

14. The apparatus of claim 13, wherein the metallic mass comprises a copper sphere.

15. The apparatus of claim 7, wherein the at least one heating element and the at least one thermocouple are engaged with the exterior surface of the conduit.

16. A method of detecting the presence of a target amount of gas flowing within a conduit, comprising:
providing a heating element in operational contact with the conduit;
heating at least one of the conduit or the gas flowing within the conduit;
measuring the temperature of at least one of the heating element, the conduit or the gas flowing within the conduit;
comparing the measured temperature of at least one of the heating element, the conduit or the gas flowing within the conduit to data relating to a target temperature;
controlling and measuring the amount of energy consumed by the heating element in order to maintain the target temperature;
correlating the amount of energy consumed by the heating element in order to maintain the target temperature with an amount of gas flowing within the conduit; and
determining whether the amount of gas flowing within the conduit is at least the target amount of gas flowing within the conduit.

17. A method for determining a volumetric flow of a gas flowing within a conduit, comprising the method of claim 16, further comprising determining the volumetric flow of the gas flowing within the conduit by analyzing the amount of gas flowing within the conduit in conjunction with a cross-sectional flow area of the conduit.
